(19) United States
(12) Patent Application Publication
(10) Pub. No.: US 2013/0107789 A1
(43) Pub. Date: May 2, 2013

(54) METHOD AND APPARATUS FOR TRANSMITTING AND RECEIVING DATA

(71) Applicants: Eunkyung Kim, Daejeon (KR); Soojung Jung, Daejeon (KR); Jae Sun Cha, Daejeon (KR); Sung Cheol Chang, Daejeon (KR); Hyun Lee, Daejeon (KR); Chul Sik Yoon, Seoul (KR)

(72) Inventors: Eunkyung Kim, Daejeon (KR); Soojung Jung, Daejeon (KR); Jae Sun Cha, Daejeon (KR); Sung Cheol Chang, Daejeon (KR); Hyun Lee, Daejeon (KR); Chul Sik Yoon, Seoul (KR)

(73) Assignee: ELECTRONICS AND TELECOMMUNICATIONS RESEARCH INSTITUTE, Daejeon (KR)

(21) Appl. No.: 13/807,291

(22) PCT Filed: Jun. 28, 2011
(86) PCT No.: PCT/KR2011/004719

§ 371 Date: Dec. 27, 2012

(30) Foreign Application Priority Data
Jun. 28, 2010 (KR) 10-2010-0061348
Jul. 14, 2010 (KR) 10-2010-0067858
Jun. 28, 2011 (KR) 10-2011-0062841

(51) Int. Cl. H04W 72/00

(52) U.S. Cl. CPC H04W 72/005
USPC 370/312

(57) ABSTRACT

A data transmission apparatus transmits a first control message including information needed for a data receiving apparatus to receive multicast broadcast service (MBS) data to the data receiving apparatus, and allocates a first carrier to the data receiving apparatus as a secondary carrier. The data transmission apparatus activates the first carrier without a procedure for exchanging a second control message for activating a carrier after the transmission of the first control message is achieved. The data transmission apparatus transmits MBS data to the data receiving apparatus through the first carrier.

### TECHNICAL FIELD

The present invention relates to a method for transmitting and receiving data and an apparatus thereof. Particularly, the present invention relates to a method and apparatus for transmitting and receiving multicast broadcast service (MBS) data.

### BACKGROUND ART

A data transmission apparatus can allocate a carrier for transmitting a multicast broadcast service (MBS) to a data receiving apparatus as a subcarrier.

In order for the data receiving apparatus to receive MBS data through the subcarrier, the data transmission apparatus has a need to activate the carrier for the MBS and to transmit information needed for the data receiving apparatus to receive the MBS data through the carrier.

For example, allocating a carrier for an MBS is performed through a multicarrier request message and a multicarrier response message, activating the carrier for the MBS is performed through a carrier management command message and a carrier management indication message, and information for receiving MBS data through the carrier is transmitted through a dynamic service addition message.

However, a procedure for exchanging the several messages as above is performed when setting an MBS, and thereby a procedure for setting an MBS becomes more complex and messages included overlapped information are exchanged.

### DISCLOSURE

### Technical Problem

The present invention has been made in an effort to provide a method for efficiently and optimally setting an MBS based on a simplified procedure from which exchanging messages including overlapped information is eliminated.

### Technical Solution

An exemplary embodiment of the present invention provides a method for a data transmission apparatus to transmit data to a data receiving apparatus. The method includes: transmitting a first control message including information needed for the data receiving apparatus to receive multicast broadcast service (MBS) data and allocating a first carrier to the data receiving apparatus as a secondary carrier; activating the first carrier for MBS data transmission to the data receiving apparatus without exchanging a second control message for activating a carrier after the transmitting of the first control message is achieved; and transmitting MBS data to the data receiving apparatus through the first carrier.

The data transmission method may further include activating the first carrier to transmit non-MBS data to the data receiving apparatus by performing a procedure for exchanging the second control message, and transmitting non-MBS data to the data receiving apparatus through the first carrier.

The first carrier may correspond to a mixed carrier for non-MBS and MBS, and the transmitting of non-MBS data may include transmitting non-MBS data and MBS data to the data receiving apparatus through the first carrier.

The information needed for the data receiving apparatus to receive the MBS data may include an MBS zone identifier field, an MBS service flow parameter, and a physical carrier index.

The transmitting of the first control message may include transmitting the first control message to the data receiving apparatus through a second carrier corresponding to a primary carrier.

The performing of a procedure for exchanging the second control message may include performing a procedure for exchanging the second control message through the second carrier.

The data receiving apparatus may include one transceiver, and the transmitting of MBS data to the data receiving apparatus through the first carrier may include transmitting non-MBS data to the data receiving apparatus through the second carrier corresponding to the primary carrier by performing scheduling for the data receiving apparatus and transmitting MBS data to the data receiving apparatus through the first carrier.

The data transmission method further includes transmitting a third control message for changing a primary carrier into the first carrier to the data receiving apparatus and changing the primary carrier of the data receiving apparatus into the first carrier, and transmitting MBS data and non-MBS data to the data receiving apparatus through the first carrier.

Another exemplary embodiment of the present invention provides a method for a data receiving apparatus to receive data from a data transmission apparatus. The method includes: receiving a first control message including information needed for receiving multicast broadcast service (MBS) data from the data transmission apparatus to be allocated a first carrier as a secondary carrier; activating the first carrier for MBS data transmission without exchanging a second control message for activating a carrier after the transmitting of the first control message is achieved; and receiving MBS data from the data transmission apparatus through the first carrier.

The data receiving method may further include activating the first carrier to receive non-MBS data by performing a procedure for exchanging the second control message, and receiving non-MBS data from the data transmission apparatus through the first carrier.

The first carrier may correspond to a mixed carrier for non-MBS and MBS, and the receiving of non-MBS data may include receiving non-MBS data and MBS data through the first carrier.

The receiving of the first control message may include receiving the first control message through a second carrier corresponding to a primary carrier, and the performing of a procedure for exchanging the second control message may include performing of a procedure for exchanging the second control message through the second carrier.

The data receiving apparatus may include one transceiver, and the receiving of MBS data from the data transmission apparatus through the first carrier may include receiving non-MBS data from the data transmission apparatus through the second carrier corresponding to the primary carrier by performing carrier switching and receiving MBS data from the data transmission apparatus through the first carrier.

The data receiving method may include receiving a third control message for changing a primary carrier into the first carrier from the data transmission apparatus and changing the primary carrier of the data receiving apparatus into the first carrier, and receiving MBS data and non-MBS data from the data transmission apparatus through the first carrier.

Yet another exemplary embodiment of the present invention provides a method for a data transmission apparatus to transmit data to a data receiving apparatus. The method includes: transmitting a first control message for allocating a secondary carrier to the data receiving apparatus and allocating a secondary carrier for transmitting multicast broadcast service (MBS) data to the data receiving apparatus; activating the secondary carrier for non-MBS data transmission; transmitting non-MBS data to the data receiving apparatus through the secondary carrier; transmitting a second control message including information needed for the data receiving apparatus to receive MBS data to activate the secondary carrier for MBS data transmission; and transmitting MBS data to the data receiving apparatus through the secondary carrier.

The secondary carrier may correspond to a mixed carrier for non-MBS and MBS, and the transmitting of non-MBS data to the data receiving apparatus through the secondary carrier may include transmitting non-MBS data and MBS data to the data receiving apparatus through the secondary carrier.

The transmitting of the first control message to the data receiving apparatus may include transmitting the first control message to the data receiving apparatus through a primary carrier, and the transmitting of the second control message to the data receiving apparatus may include transmitting the second control message to the data receiving apparatus through the primary carrier.

The activating of the secondary carrier may include transmitting a third control message for activating a carrier to the data receiving apparatus to activate the secondary carrier for non-MBS data transmission.

Yet another exemplary embodiment of the present invention provides a method for a data receiving apparatus to receive data. The method includes: receiving a first control message for allocating a secondary carrier from the data transmission apparatus to be allocated a secondary carrier for multicast broadcast service (MBS) data transmission; activating the secondary carrier for receiving non-MBS data; receiving non-MBS data from the data transmission apparatus through the secondary carrier; receiving a second control message including information needed for the data receiving apparatus to receive MBS data from the data transmission apparatus and activating the secondary carrier for MBS data transmission; and receiving MBS data from the data transmission apparatus through the secondary carrier.

The secondary carrier may correspond to a mixed carrier for non-MBS and MBS, and the receiving of non-MBS data may include receiving non-MBS data and MBS data from the data transmission apparatus through the secondary carrier.

Yet another exemplary embodiment of the present invention provides a method for a data transmission apparatus to transmit data to a data receiving apparatus including one transceiver. The method includes: transmitting a first control message including information needed for the data receiving apparatus to receive multicast broadcast service (MBS) data and allocating a first carrier to the data receiving apparatus as a secondary carrier; additionally activating the first carrier for MBS data transmission to the data receiving apparatus without exchanging a second control message for activating a carrier after the transmitting of the first control message is achieved; and transmitting MBS data and non-MBS data to the data receiving apparatus through the first carrier.

The method may further include: transmitting a third control message for changing a primary carrier into a second carrier to the data receiving apparatus and changing a primary carrier of the data receiving apparatus into the second carrier; and transmitting non-MBS data to the data receiving apparatus through the second carrier by performing scheduling for the data receiving apparatus and transmitting MBS data to the data receiving apparatus through the first carrier.

Yet another exemplary embodiment of the present invention provides a method for a data receiving apparatus including one transceiver to receive data from a data transmission apparatus. The method includes: receiving a first control message including information needed for receiving multicast broadcast service (MBS) data through a first carrier corresponding to a primary carrier from the data transmission apparatus; additionally activating the first carrier for MBS data transmission to the data receiving apparatus without exchanging a second control message for activating a carrier after the transmitting of the first control message is achieved; and receiving MBS data and non-MBS data from the data transmission apparatus through the first carrier.

The method may further include receiving a third control message for changing a primary carrier into a second carrier from the data transmission apparatus and changing a primary carrier of the data receiving apparatus into the second carrier, and receiving non-MBS data from the data transmission apparatus through the second carrier by a carrier switching and receiving MBS data from the data transmission apparatus through the first carrier.

The data transmission apparatus may correspond to a base station or a relay station, and the data receiving apparatus may correspond to a mobile station.

### Advantageous Effects

According to the embodiments of the present invention, by dividing a control message for allocating and activating a carrier for transmitting non-MBS data such as unicast data and a control message for allocating and activating a carrier for transmitting MBS data, it is possible to simplify a procedure for setting an MBS and to eliminate a procedure for exchanging messages including overlapped information. This allows the delay in setting an MBS to be reduced and also prevents a waste of bandwidth, and thereby efficient and optimized carrier allocation can be performed.

### DESCRIPTION OF THE DRAWINGS

FIG. 1 shows a ladder diagram illustrating the operation of a data transmission apparatus and a data receiving apparatus according to the first exemplary embodiment of the present invention.

FIG. 2 shows a ladder diagram illustrating the operation of a data transmission apparatus and a data receiving apparatus according to the second exemplary embodiment of the present invention.

FIG. 3 shows a ladder diagram illustrating the operation of a data transmission apparatus and a data receiving apparatus according to the third exemplary embodiment of the present invention.

FIG. 4 shows a ladder diagram illustrating the operation of a data transmission apparatus and a data receiving apparatus according to the fourth exemplary embodiment of the present invention.

FIG. 5 shows a ladder diagram illustrating the operation of a data transmission apparatus and a data receiving apparatus according to the fifth exemplary embodiment of the present invention.

FIG. 6 shows a ladder diagram illustrating the operation of a data transmission apparatus and a data receiving apparatus according to the sixth exemplary embodiment of the present invention.

FIG. 7 shows a ladder diagram illustrating the operation of a data transmission apparatus and a data receiving apparatus according to the seventh exemplary embodiment of the present invention.

FIG. 8 shows a block diagram illustrating a construction of a data transmission apparatus according to the exemplary embodiment of the present invention.

FIG. 9 shows a block diagram illustrating construction of a data receiving apparatus according to the exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the specification, in addition, unless explicitly described to the contrary, the word “comprise” and variations such as “comprises” or “comprising” will be understood to imply the inclusion of stated elements but not the exclusion of any other elements.

In this specification, a mobile station (MS) may refer to a terminal, a mobile terminal (MT), a subscriber station (SS), a portable subscriber station (PSS), user equipment (UE), or an access terminal (AT). The mobile terminal may include all or part of the functions of the mobile station, the subscriber station, the portable subscriber station, and the user equipment. In this specification, a base station (BS) may refer to an access point (AP), a radio access station (RAS), a node B, a base transceiver station (BTS), or an MMR (mobile multihop relay)-BS. The base station may include all or part of the functions of the access point, the radio access station, the node B, the base transceiver station, and the MMR-BS.

Further, in the specification, transmitting covers unicasting, multicasting, and broadcasting.

Also, in the specification, a mixed carrier means a carrier that may be used in transmitting both non-multicast broadcast service (MBS) data such as unicast data and MBS data, and a dedicated carrier means a carrier that may not be used in transmitting non-MBS data, but transmitting MBS data.

In addition, in the specification, a data transmission apparatus and a data receiving apparatus may transmit or receive a multicarrier-specific message and a dynamic service addition (DSA) message.

The multicarrier-specific message includes a multicarrier request message (MC-REQ message), a multicarrier response message (MC-RSP message), a carrier management command MAC control message (CM-CMD message), a carrier management indication MAC control message (CM-IND message), and others.

The multicarrier request message is transmitted by a data receiving apparatus to a data transmission apparatus to request a list of allocated carriers.

The data transmission transmits a multicarrier response message to the data receiving apparatus based on the multicarrier request message to provide information on allocated carriers to the data receiving apparatus. Particularly, the data transmission apparatus transmits the multicarrier response message to the data receiving apparatus to allocate a secondary carrier to the data receiving apparatus.

For changing a primary carrier, activating a secondary carrier, and deactivating a secondary carrier, the data transmission apparatus may transmit a carrier management command MAC control message to the data receiving apparatus. The data receiving apparatus transmits a carrier management indication MAC control message to the data transmission apparatus in response to the carrier management command MAC control message.

The dynamic service addition message includes a dynamic service addition request message (DSA-REQ message) and a dynamic service addition response message (DSA-RSP message). The dynamic service addition request message is transmitted by the data transmission apparatus or the data receiving apparatus to generate a new service flow.

When starting an MBS service flow, the data transmission apparatus may transmit a dynamic service addition message including an MBS service field, an MBS zone identifier field, an MBS service flow parameter, and a physical carrier index to the data receiving apparatus.

The MBS service field represents that an MBS service is requested or is provided for a connection being set up. The MBS zone identifier field represents an MBS zone in which a connection for a related service flow is valid. The MBS service flow parameter includes information on mapping an MBS identifier and a flow identifier. The physical carrier index represents a target carrier to which a data receiving apparatus is switched or through which an MBS service is provided.

Meanwhile, the dynamic service addition response message is transmitted by a data transmission apparatus or a data receiving apparatus to respond to the dynamic service addition request message. When starting an MBS service flow, the data receiving apparatus may transmit a dynamic service addition response message including an MBS service field, an MBS zone identifier field, an MBS service flow parameter, and a physical carrier index to the data receiving apparatus.

As above, when the MBS service flow is started, the data transmission apparatus a dynamic service addition request message including information needed for receiving an MBS service to the data receiving apparatus.

A procedure for exchanging a multicarrier-specific message may mean exchanging a multicarrier request message and a multicarrier response message or exchanging a carrier managements command MAC control message and a carrier management indication MAC control message between the data transmission apparatus and the data receiving apparatus.

The procedure for exchanging a multicarrier request response message may mean exchanging a multicarrier request message and a multicarrier response message between the data transmission apparatus and the data receiving apparatus. The procedure for exchanging a carrier management message may mean exchanging a carrier management command MAC control message and a carrier management indication MAC control message between the data transmission apparatus and the data receiving apparatus.

The procedure for exchanging a dynamic service addition message may mean exchanging a dynamic service addition request message and a dynamic service addition response message between the data transmission apparatus and the data receiving apparatus.

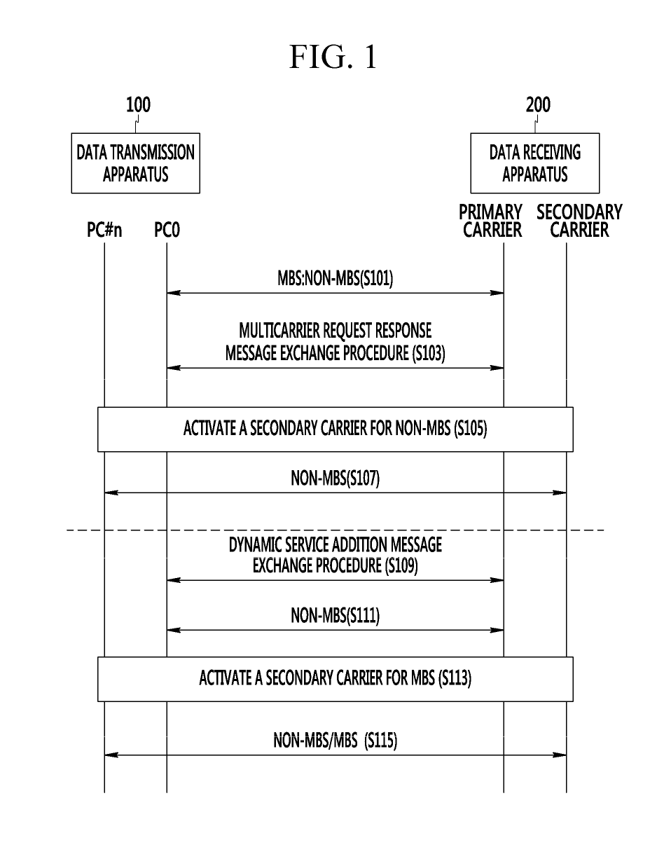

Next, referring to FIG. 1 to FIG. 7, the operation of the data transmission apparatus and the data receiving apparatus according to an exemplary embodiment of the exemplary embodiment will be described.

FIG. 1 shows a ladder diagram illustrating the operation of the data transmission apparatus and the data receiving apparatus according to the first exemplary embodiment of the present invention.

In FIG.1, a data transmission apparatus 100 assumes that a carrier PC0 is allocated to a data receiving apparatus 200 as a primary carrier to transmit non-MBS data such as unicast data.

The data transmission apparatus 100 transmits non-MBS data to the data receiving apparatus 200 through the primary carrier, or the data receiving apparatus 200 transmits non-MBS data to the data transmission apparatus 100 through the primary carrier (S101).

After this, the data transmission apparatus 100 and the data receiving apparatus 200 perform a multicarrier request response message exchange procedure through the primary carrier so that the data transmission apparatus 100 allocates a mixed carrier PC#n to the data receiving apparatus 200 as a secondary carrier to transmit non-MBS data (S103).

The data transmission apparatus 100 and the data receiving apparatus 200 activate the allocated secondary carrier for the non-MBS data transmission (S105). Here, the data transmission apparatus 100 the data receiving apparatus 200 may activate the allocated secondary carrier for the non-MBS data transmission right after the successful multicarrier request response message exchange procedure or by performing a carrier management message exchange procedure through the primary carrier.

After the secondary carrier is activated, the data transmission apparatus 100 transmits non-MBS data to the data receiving apparatus 200 through the allocated secondary carrier, or the data receiving apparatus 200 transmits non-MBS data to the data transmission apparatus 100 through the allocated secondary carrier (S107).

Meanwhile, for MBS data transmission through a secondary carrier, the data transmission apparatus 100 and the data receiving apparatus 200 perform a dynamic service addition message exchange procedure through a primary carrier, and the data transmission apparatus 100 transmits information needed for the data receiving apparatus 200 to receive MBS data through a secondary carrier to the data receiving apparatus 200 (S109).

After the dynamic service addition message exchange procedure, the primary carrier may be continuously used for the non-MBS data transmission (S111).

The data transmission apparatus 100 and the data receiving apparatus 200 activate the allocated secondary carrier after the successful dynamic service addition message exchange procedure without a multicarrier-specific message exchange procedure such as a multicarrier request response message exchange procedure or a carrier management message exchange procedure (S113). The data transmission apparatus 100 and the data receiving apparatus 200 may activate the allocated secondary carrier right after the successful dynamic service addition message exchange procedure. Also, when the data receiving apparatus 200 informs the data transmission apparatus 100 of an MBS-receiving time point, the data transmission apparatus 100 and the data receiving apparatus 200 may activate the allocated carrier at the informed time point.

The secondary carrier is additionally activated for MBS data transmission through the dynamic service addition message exchange procedure, and thereby the secondary carrier may be used for transmitting non-MBS data and MBS data (S115).

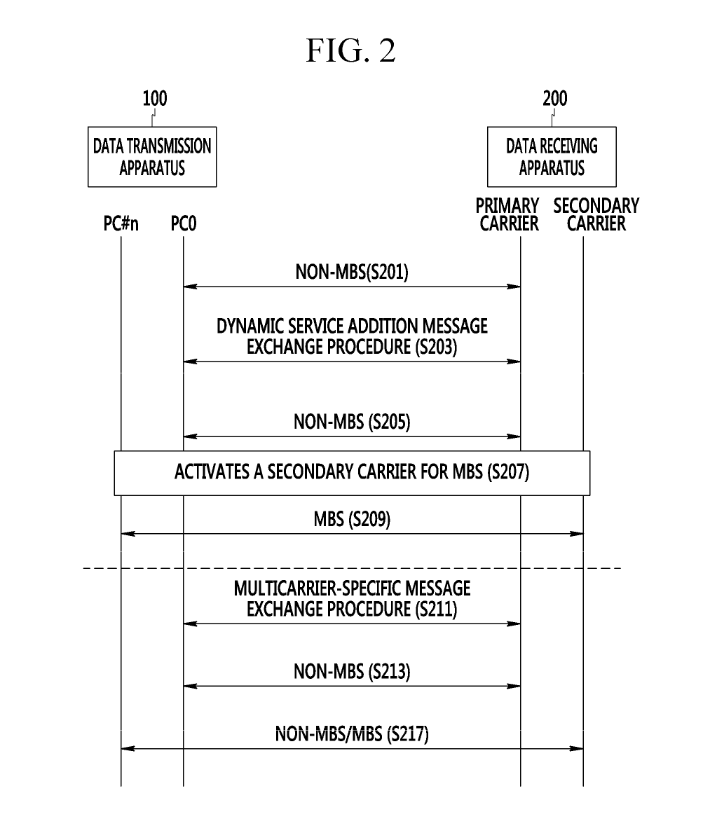

FIG. 2 shows a ladder diagram illustrating the operation of a data transmission apparatus and a data receiving apparatus according to the second exemplary embodiment of the present invention.

In FIG. 2, it is assumed that the data transmission apparatus 100 allocates a carrier PC0 to the data receiving apparatus 200 as a primary carrier for non-MBS data transmission.

The data transmission apparatus 100 transmits non-MBS data to the data receiving apparatus 200 through the primary carrier or the data receiving apparatus 200 transmits non-MBS data to the data transmission apparatus 100 through the primary carrier (S201).

Meanwhile, for MBS data transmission through a secondary carrier, the data transmission apparatus 100 and the data receiving apparatus 200 perform a dynamic service addition message exchange procedure through the primary carrier so that the data transmission apparatus 100 transmits the information needed for the data receiving apparatus 200 to receive MBS data through the secondary carrier to the data receiving apparatus 200 (S203). Since the secondary carrier is not allocated, the data transmission apparatus 100 allocates a mixed carrier PC#n as the secondary carrier based on the information.

After the dynamic service addition message exchange procedure, the primary carrier may be continuously used for transmitting non-MBS data (S205).

The data transmission apparatus 100 and the data receiving apparatus 200 activate the allocated secondary carrier after the successful dynamic service addition message exchange procedure without a multicarrier-specific message exchange procedure such as a multicarrier request response message exchange procedure or a carrier management message exchange procedure (S207). The data transmission apparatus 100 and the data receiving apparatus 200 may activate the allocated secondary carrier right after the successful dynamic service addition message exchange procedure. Also, when the data receiving apparatus 200 informs the data transmission apparatus 100 of an MBS receiving time point, the data transmission apparatus 100 and the data receiving apparatus 200 may activate the allocated carrier at the informed time point.

The secondary carrier is activated for MBS data transmission, and thereby the secondary carrier may be used for transmitting MBS data (S209).

For non-MBS data transmission through the secondary carrier, the data transmission apparatus 100 and the data receiving apparatus 200 activate the secondary carrier by performing a multicarrier-specific message exchange procedure through the primary carrier (S211). Since the secondary carrier is already allocated to the data receiving apparatus 200 through the dynamic service addition message exchange procedure, the secondary carrier may be activated through a multicarrier request response message exchange procedure rather than a carrier management message exchange procedure.

After the successful multicarrier-specific message exchange procedure, the primary carrier may be continuously used for non-MBS data transmission (S213).

The secondary carrier is additionally activated for non-MBS data transmission through the multicarrier-specific message exchange procedure, and thereby the secondary carrier may be used for transmitting non-MBS data and MBS data (S215).

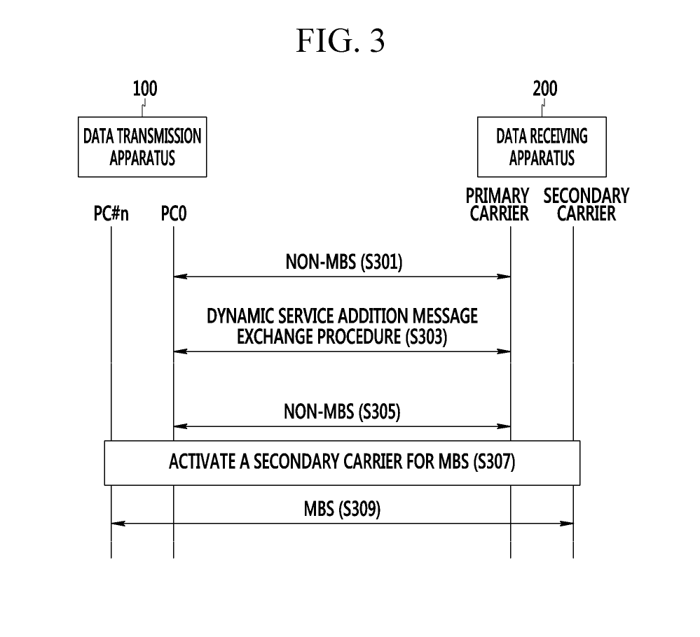

FIG. 3 shows a ladder diagram illustrating the operation of a data transmission apparatus and a data receiving apparatus according to the third exemplary embodiment of the present invention.

In FIG. 3, it is assumed that the data transmission apparatus 100 allocates a carrier PC0 to the data receiving apparatus 200 as a primary carrier for non-MBS data transmission.

The data transmission apparatus 100 transmits non-MBS data to the data receiving apparatus 200 through the primary carrier or the data receiving apparatus 200 transmits non-MBS data such as unicast data to the data transmission apparatus 100 through the primary carrier (S301).

Meanwhile, for MBS data transmission through a secondary carrier, the data transmission apparatus 100 and the data receiving apparatus 200 performs a dynamic service addition message exchange procedure through the primary carrier so that the data transmission apparatus 100 transmits information needed for the data receiving apparatus 200 to receive MBS data through the secondary carrier to the data receiving apparatus 200 (S303). Since the secondary carrier is not allocated, the data transmission apparatus 100 allocates a dedicated carrier PC#n as the secondary carrier based on the information. After the dynamic service addition message exchange procedure, the primary carrier may be continuously used for transmitting non-MBS data (S305).

The data transmission apparatus 100 and the data receiving apparatus 200 activate the allocated secondary carrier after the successful dynamic service addition message exchange procedure without a multicarrier-specific message exchange procedure such as a multicarrier request response message exchange procedure or a carrier management message exchange procedure (S307). The data transmission apparatus 100 and the data receiving apparatus 200 may activate the allocated secondary carrier right after the successful dynamic service addition message exchange procedure. Also, when the data receiving apparatus 200 informs the data transmission apparatus 100 of an MBS receiving time point, the data transmission apparatus 100 and the data receiving apparatus 200 may activate the allocated secondary carrier at the informed time point.

The secondary carrier is activated for MBS data transmission, and thereby the secondary carrier may be used for transmitting MBS data (S309).

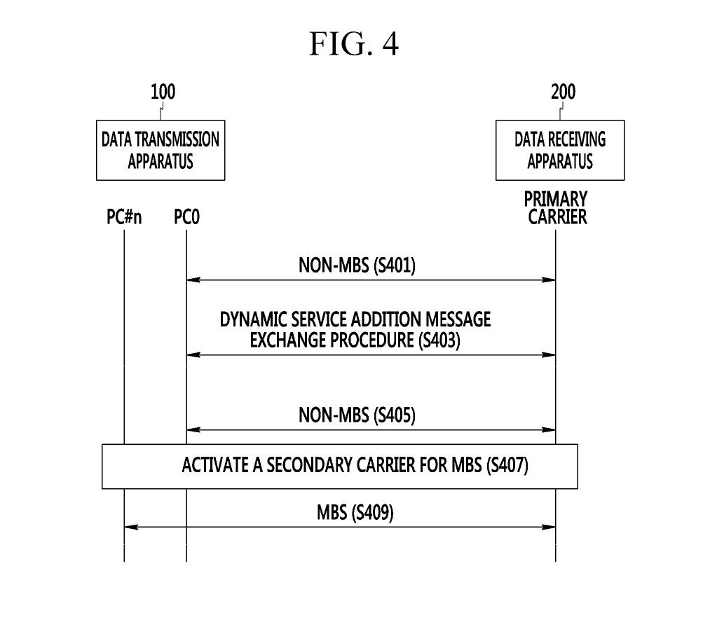

FIG. 4 shows a ladder diagram illustrating the operation of a data transmission apparatus and a data receiving apparatus according to the fourth exemplary embodiment of the present invention.

In FIG. 4, it is assumed that the data transmission apparatus 100 allocates a carrier PC0 to the data receiving apparatus 200 as a primary carrier for non-MBS data transmission, and the data receiving apparatus 200 includes one transceiver and may receive one carrier.

The data transmission apparatus 100 transmits non-MBS data to the data receiving apparatus 200 through the carrier PC0 or the data receiving apparatus 200 transmits non-MBS data such as unicast data to the data transmission apparatus 100 through the carrier PC0 (S401).

Meanwhile, for MBS data transmission through a additional carrier PC#n, the data transmission apparatus 100 and the data receiving apparatus 200 perform a dynamic service addition message exchange procedure through the carrier PC0 so that the data transmission apparatus 100 transmits information needed for the data receiving apparatus 200 to receive MBS data through the carrier PC#n to the data receiving apparatus 200 (S403). Since the carrier PC#n is not allocated, the data transmission apparatus 100 allocates the carrier PC#n based on the information. The carrier PC#n may correspond to a mixed carrier or a dedicated carrier.

After the dynamic service addition message exchange procedure, the carrier PC0 may be continuously used for transmitting non-MBS data (S405).

Meanwhile, when the data receiving apparatus 200 informs the data transmission apparatus 100 of an MBS receiving time point, the data transmission apparatus 100 and the data receiving apparatus 200 switch the primary carrier to the carrier PC#n by performing a carrier management message exchange procedure through a carrier PC0 and then activate the carrier PC#n for MBS data transmission (S407). After this, the data transmission apparatus 100 transmits MBS data to the data receiving apparatus 200 through the carrier PC#n, and the data receiving apparatus 200 receives the MBS data through the carrier PC#n (S409).

As in the above, in the steps of S405, S407, and S409, the data transmission apparatus 100 transmits MBS data and non-MBS data through scheduling so that the data receiving apparatus 200 receives the MBS data and the non-MBS data through carrier switching.

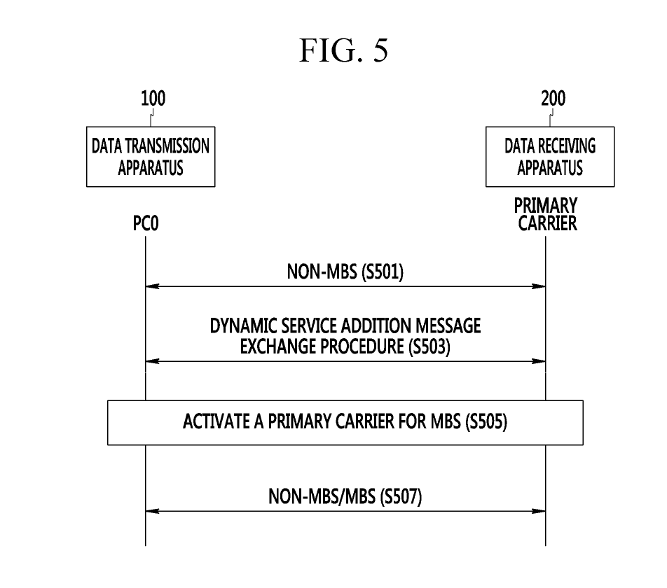

FIG. 5 shows a ladder diagram illustrating the operation of a data transmission apparatus and a data receiving apparatus according to the fifth exemplary embodiment of the present invention.

In FIG. 5, it is assumed that the data transmission apparatus 100 allocates a mixed carrier PC0 to the data receiving apparatus 200 as a primary carrier for non-MBS data transmission, and the data receiving apparatus 200 includes one transceiver and may receive one carrier.

The data transmission apparatus 100 transmits non-MBS data to the data receiving apparatus 200 through the mixed carrier PC0 or the data receiving apparatus 200 transmits non-MBS data to the data transmission apparatus 100 through the mixed carrier PC0 (S501).

Meanwhile, for MBS data transmission through the mixed carrier PC0, the data transmission apparatus 100 and the data receiving apparatus 200 perform a dynamic service addition message exchange procedure so that the data transmission apparatus 100 transmits information needed for the data receiving apparatus 200 to receive MBS data through the mixed carrier PC0 to the data receiving apparatus 200 (S503).

The data transmission apparatus 100 and the data receiving apparatus 200 activate the mixed carrier PC0 after the successful dynamic service addition message exchange procedure without a multicarrier-specific message exchange procedure such as a multicarrier request response message exchange procedure or a carrier management message exchange procedure (S505). The data transmission apparatus 100 and the data receiving apparatus 200 may additionally activate the mixed carrier PC0 for MBS data transmission right after the successful dynamic service addition message exchange procedure. Also, when the data receiving apparatus 200 informs the data transmission apparatus 100 of an MBS receiving time point, the data transmission apparatus 100 and the data receiving apparatus 200 may additionally activate the mixed carrier PCO at the informed time point.

The carrier PC0 is additionally activated for MBS data transmission through the dynamic service addition message exchange procedure, and thereby the carrier PC0 may be used for transmitting non-MBS data and MBS data (S507).

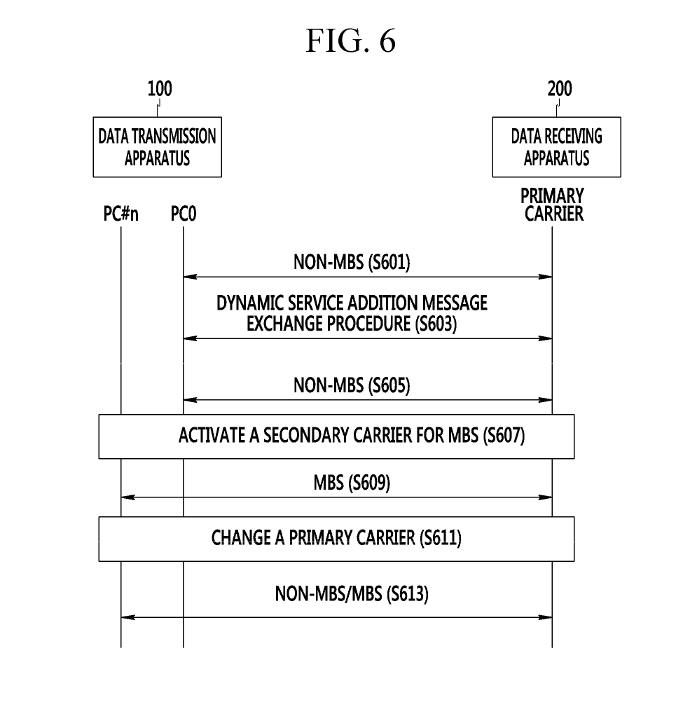

FIG. 6 shows a ladder diagram illustrating the operation of a data transmission apparatus and a data receiving apparatus according to the sixth exemplary embodiment of the present invention.

In FIG. 6, it is assumed that the data transmission apparatus 100 allocates a carrier PC0 to the data receiving apparatus 200 as a primary carrier for non-MBS data transmission, and the data receiving apparatus 200 includes one transceiver and may receive one carrier.

The data transmission apparatus 100 transmits non-MBS data to the data receiving apparatus 200 through the carrier PC0 or the data receiving apparatus 200 transmits non-MBS data to the data transmission apparatus 100 through the carrier PC0 (S601).

Meanwhile, for MBS data transmission through a mixed carrier PC#n, the data transmission apparatus 100 and the data receiving apparatus 200 perform a dynamic service addition message exchange procedure through the carrier PC0 so that the data transmission apparatus 100 transmits information needed for the data receiving apparatus 200 to receive MBS data through the carrier PC#n to the data receiving apparatus 200 (S603). Since the carrier PC#n is not allocated, the data transmission apparatus 100 allocates the carrier PC#n based on the information. The carrier PC#n may correspond to a mixed carrier or a dedicated carrier.

After the dynamic service addition message exchange procedure, the carrier PC0 may be continuously used for transmitting non-MBS data (S605).

Meanwhile, when the data receiving apparatus 200 informs the data transmission apparatus 100 of an MBS receiving time point, the data transmission apparatus 100 and the data receiving apparatus 200 switch the primary carrier to the carrier PC#n by performing a carrier management message exchange procedure through the carrier PC0 and then activate the carrier PC#n for MBS data transmission (S607).

After this, the data transmission apparatus 100 transmits MBS data to the data receiving apparatus 200 through the carrier PC#n, and the data receiving apparatus 200 receives the MBS data through the carrier PC#n (S609).

As in the above, in the steps of S605, S607, and S609, the data transmission apparatus 100 transmits MBS data and non-MBS data through scheduling so that the data receiving apparatus 200 receives the MBS data and the non-MBS data through carrier switching.

When the primary carrier of the data receiving apparatus 200 is needed to be changed, the data transmission apparatus 100 and the data receiving apparatus 200 perform a carrier management message exchange procedure, change the primary of the data receiving apparatus 200 into the carrier PC#n, and activate the carrier PC#n for non-MBS data transmission (S611).

After the primary carrier is changed into the carrier PC#n, non-MBS data and MBS data may be transmitted through the carrier PC#n without carrier switching (S613).

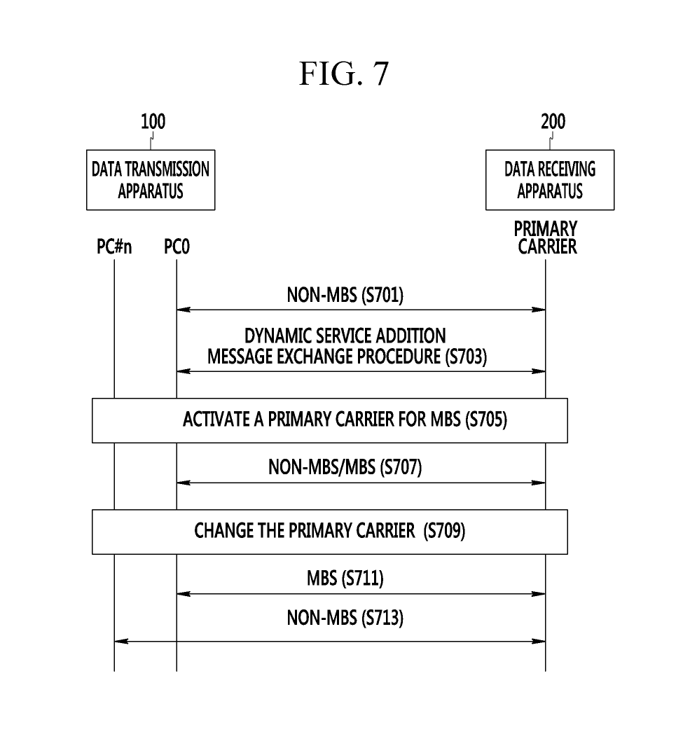

FIG. 7 shows a ladder diagram illustrating the operation of a data transmission apparatus and a data receiving apparatus according to the seventh exemplary embodiment of the present invention.

In FIG. 7, it is assumed that the data transmission apparatus 100 allocates a carrier PC0 to the data receiving apparatus 200 as a primary carrier for non-MBS data transmission, and the data receiving apparatus 200 includes one transceiver and may receive one carrier.

The data transmission apparatus 100 transmits non-MBS data to the data receiving apparatus 200 through a mixed carrier PC0 or the data receiving apparatus 200 transmits non-MBS data to the data transmission apparatus 100 through the mixed carrier PC0 (S701).

Meanwhile, for MBS data transmission through the mixed carrier PC0, the data transmission apparatus 100 and the data receiving apparatus 200 perform a dynamic service addition message exchange procedure through the carrier PC0 so that the data transmission apparatus 100 transmits information needed for the data receiving apparatus 200 to receive MBS data through the carrier PC0 to the data receiving apparatus 200 (S703).

The data transmission apparatus 100 and the data receiving apparatus 200 additionally activate the mixed carrier PC0 after the successful dynamic service addition message exchange procedure without a multicarrier-specific message exchange procedure such as a multicarrier request response message exchange procedure or a carrier management message exchange procedure (S705).

The data transmission apparatus 100 and the data receiving apparatus 200 may additionally activate the mixed carrier PC0 right after the successful dynamic service addition message exchange procedure. Also, when the data receiving apparatus 200 informs the data transmission apparatus 100 of an MBS receiving time point, the data transmission apparatus 100 and the data receiving apparatus 200 may activate the allocated carrier at the informed time point.

The mixed carrier PC0 is additionally activated for MBS data transmission through the dynamic service addition message exchange procedure, and thereby the mixed carrier PC0 may be used for transmitting non-MBS data and MBS data (S707).

When the primary carrier of data receiving apparatus 200 is needed to be changed, the data transmission apparatus 100 and the data receiving apparatus 200 perform a carrier management message exchange procedure and change the primary data receiving apparatus 200 into a carrier PC#n (S709).

The primary carrier is changed into the carrier PC#n for non-MBS data transmission, and then the data receiving apparatus 200 receives multicast data through the carrier PC0 (S711) and performs carrier switching of the carrier PC0 into the carrier PC#n to transmit or receive non-MBS data through the carrier

PC#n (S713).

As in the above, in the steps of S711 and S713, the data transmission apparatus 100 transmits MBS data and non-MBS data through scheduling so that the data receiving apparatus 200 receives the MBS data and the non-MBS data through the carrier switching.

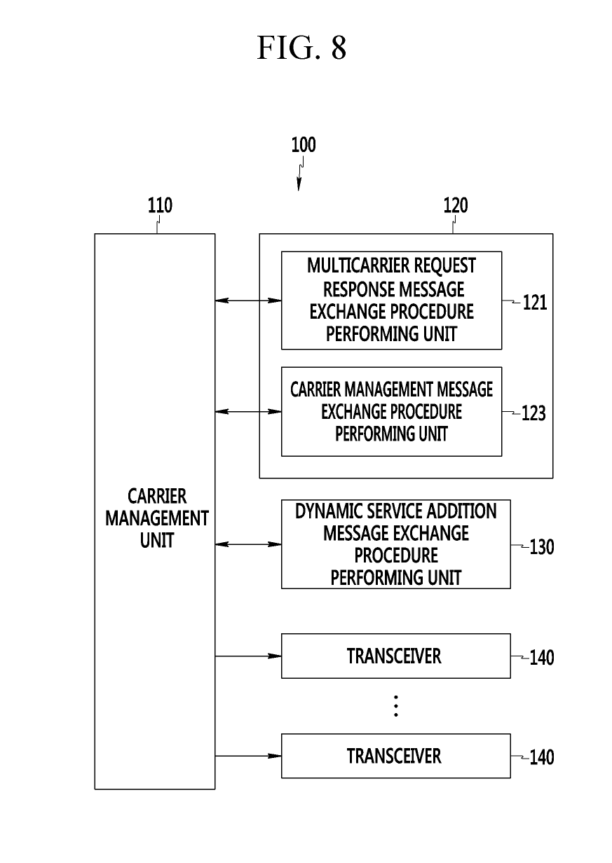

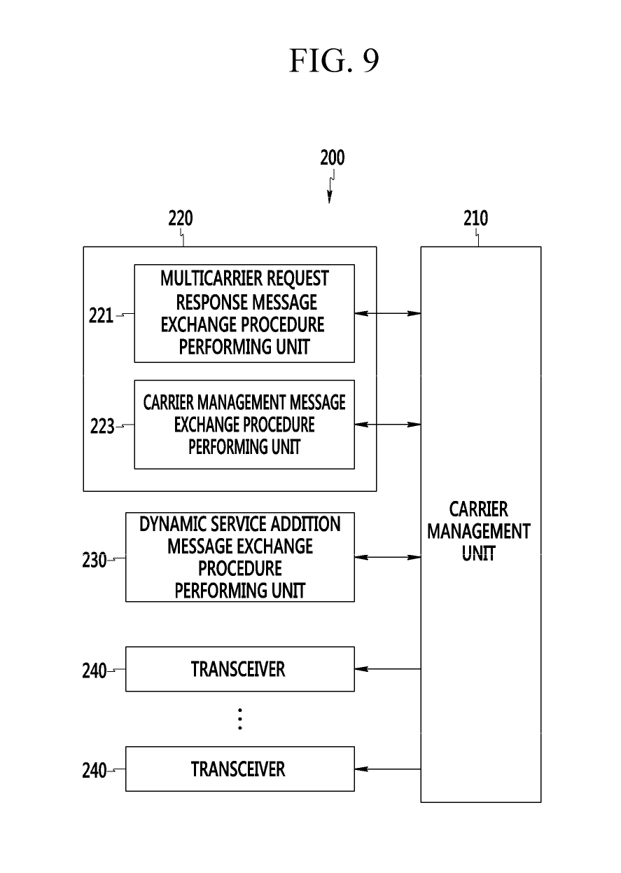

Next, referring to FIGS. 8 and 9, the constructions of the data transmission apparatus 100 and the data receiving apparatus 200 according to an exemplary embodiment of the present invention will be described.

FIG. 8 shows a block diagram illustrating the construction of the data transmission apparatus according to the exemplary embodiment of the present invention.

As shown in FIG. 8, the data transmission apparatus 100 according to an exemplary embodiment of the present invention includes a carrier management unit 110, a multicarrier-specific message exchange procedure performing unit 120, a dynamic service addition message exchange procedure performing unit 130, and a plurality of transceivers 140. The multicarrier-specific message exchange procedure performing unit 120 includes a multicarrier request response message exchange procedure performing unit 121 and a carrier management message exchange procedure performing unit 123.

The carrier management unit 110 allocates, deallocates, activates, or deactivates a primary carrier and a secondary carrier for the data receiving apparatus 200 through a multicarrier-specific message exchange procedure, a multicarrier request response message exchange procedure, a carrier management message exchange procedure, and a dynamic service addition message exchange procedure.

The multicarrier-specific message exchange procedure performing unit 120 performs the multicarrier-specific message exchange procedure with the data receiving apparatus 200.

The multicarrier request response message exchange procedure performing unit 121 performs the multicarrier request response message exchange procedure with the data receiving apparatus 200.

The carrier management message exchange procedure performing unit 123 performs the carrier management message exchange procedure with the data receiving apparatus 200.

The dynamic service addition message exchange procedure performing unit 130 performs the dynamic service addition message exchange procedure with the data receiving apparatus 200.

The plurality of transceivers 140 correspond to a plurality of carriers, respectively. Each transceiver 140 transmits non-MBS data and MBS data through a corresponding carrier based on carrier management of the carrier management unit 110 and receives non-MBS data from the data receiving apparatus 200 through the corresponding carrier.

FIG. 9 shows a block diagram illustrating the construction of the data receiving apparatus according to the exemplary embodiment of the present invention.

As shown in FIG. 9, the data receiving apparatus 200 according to an exemplary embodiment of the present invention includes a carrier management unit 210, a multicarrier-specific message exchange procedure performing unit 220, a dynamic service addition message exchange procedure performing unit 230, and a plurality of transceivers 240. The multicarrier-specific message exchange procedure performing unit 220 includes a multicarrier request response message exchange procedure performing unit 221 and a carrier management message exchange procedure performing unit 223. The data receiving apparatus 200 may receive one carrier with one transceiver 240.

The carrier management unit 210 allocates, deallocates, activates, or deactivates a primary carrier and a secondary carrier for the data receiving apparatus 200 through a multicarrier-specific message exchange procedure, a multicarrier request response message exchange procedure, a carrier management message exchange procedure, and a dynamic service addition message exchange procedure.

The multicarrier-specific message exchange procedure performing unit 220 performs the multicarrier-specific message exchange procedure with the data transmission apparatus 100.

The multicarrier request response message exchange procedure performing unit 221 performs the multicarrier request response message exchange procedure with the data transmission apparatus 100.

The carrier management message exchange procedure performing unit 223 performs the carrier management message exchange procedure with the data transmission apparatus 100.

The dynamic service addition message exchange procedure performing unit 230 performs the dynamic service addition message exchange procedure with the data transmission apparatus 100.

The plurality of transceivers 240 correspond to a plurality of carriers, respectively. Each transceiver 240 receives non-MBS data and MBS data through a corresponding carrier based on carrier management of the carrier management unit 210 and transmits non-MBS data to the data receiving apparatus 200 through the corresponding carrier.

As in the above, through separating a control message for allocation and activation of a carrier to transmit non-MBS data and a control message for allocation and activation of a carrier to transmit MBS data, setting procedures of the MBS may be simplified and a procedure for exchanging messages including overlapping information may be eliminated. Therefore, it is possible to reduce delays in MBS setting and to prevent the waste of bandwidth, and thereby efficient and optimized carrier allocation may be performed.

In the exemplary embodiments of the present invention, the data transmission apparatus may correspond to a base station or a relay station, and the data receiving apparatus may correspond to a mobile station.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for a data transmission apparatus to transmit data to a data receiving apparatus, comprising:
transmitting a first control message including information needed for the data receiving apparatus to receive multicast broadcast service (MBS) data and allocating a first carrier to the data receiving apparatus as a secondary carrier;
activating the first carrier for MBS data transmission to the data receiving apparatus without exchanging a second control message for activating a carrier after the transmitting of the first control message is achieved; and
transmitting MBS data to the data receiving apparatus through the first carrier.

2. The method of claim 1, further comprising:
activating the first carrier to transmit non-MBS data to the data receiving apparatus by performing a procedure for exchanging the second control message; and
transmitting non-MBS data to the data receiving apparatus through the first carrier.

3. The method of claim 2, wherein the first carrier corresponds to a mixed carrier for non-MBS and MBS, and
the transmitting of non-MBS data includes transmitting non-MBS data and MBS data to the data receiving apparatus through the first carrier.

4. The method of claim 3, wherein the information needed for the data receiving apparatus to receive the MBS data includes an MBS zone identifier field, an MBS service flow parameter, and a physical carrier index.

5. The method of claim 2, wherein the transmitting of the first control message includes transmitting the first control message to the data receiving apparatus through a second carrier corresponding to a primary carrier.

6. The method of claim 5, wherein the performing of a procedure for exchanging the second control message includes performing a procedure for exchanging the second control message through the second carrier.

7. The method of claim 1, wherein the data receiving apparatus includes one transceiver, and
the transmitting of MBS data to the data receiving apparatus through the first carrier includes transmitting non-MBS data to the data receiving apparatus through the second carrier corresponding to the primary carrier by performing scheduling for the data receiving apparatus and transmitting MBS data to the data receiving apparatus through the first carrier.

8. The method of claim 7, further comprising:
transmitting a third control message for changing a primary carrier into the first carrier to the data receiving apparatus and changing the primary carrier of the data receiving apparatus into the first carrier; and
transmitting MBS data and non-MBS data to the data receiving apparatus through the first carrier.

9. A method for a data receiving apparatus to receive data from a data transmission apparatus, comprising:
receiving a first control message including information needed for receiving multicast broadcast service (MBS) data from the data transmission apparatus to be allocated a first carrier as a secondary carrier;
activating the first carrier for MBS data transmission without exchanging a second control message for activating a carrier after the transmitting of the first control message is achieved; and
receiving MBS data from the data transmission apparatus through the first carrier.

10. The method of claim 9, further comprising:
activating the first carrier to receive non-MBS data by performing a procedure for exchanging the second control message; and
receiving non-MBS data from the data transmission apparatus through the first carrier.

11. The method of claim 10, wherein the first carrier corresponds to a mixed carrier for non-MBS and MBS, and
the receiving of non-MBS data includes receiving non-MBS data and MBS data through the first carrier.

12. The method of claim 10, wherein the receiving of the first control message includes receiving the first control message through a second carrier corresponding to a primary carrier, and
the performing of a procedure for exchanging the second control message includes performing of a procedure for exchanging the second control message through the second carrier.

13. The method of claim 9, wherein the data receiving apparatus includes one transceiver, and
the receiving of MBS data from the data transmission apparatus through the first carrier includes receiving non-MBS data from the data transmission apparatus through the second carrier corresponding to the primary carrier by performing carrier switching and receiving MBS data from the data transmission apparatus through the first carrier.

14. The method of claim 13, further comprising:
receiving a third control message for changing a primary carrier into the first carrier from the data transmission apparatus and changing the primary carrier of the data receiving apparatus into the first carrier; and
receiving MBS data and non-MBS data from the data transmission apparatus through the first carrier.

15. A method for a data transmission apparatus to transmit data to a data receiving apparatus, comprising:
transmitting a first control message for allocating a secondary carrier to the data receiving apparatus and allocating a secondary carrier for transmitting multicast broadcast service (MBS) data to the data receiving apparatus;
activating the secondary carrier for non-MBS data transmission;
transmitting non-MBS data to the data receiving apparatus through the secondary carrier;
transmitting a second control message including information needed for the data receiving apparatus to receive MBS data to activate the secondary carrier for MBS data transmission; and
transmitting MBS data to the data receiving apparatus through the secondary carrier.

16. The method of claim 15, wherein the secondary carrier corresponds to a mixed carrier for non-MBS and MBS, and
the transmitting of non-MBS data to the data receiving apparatus through the secondary carrier includes transmitting non-MBS data and MBS data to the data receiving apparatus through the secondary carrier.

17. The method of claim 15, wherein the transmitting of the first control message to the data receiving apparatus includes transmitting the first control message to the data receiving apparatus through a primary carrier, and
the transmitting of the second control message to the data receiving apparatus includes transmitting the second control message to the data receiving apparatus through the primary carrier.

18. The method of claim 15, wherein the activating of the secondary carrier includes transmitting a third control message for activating a carrier to the data receiving apparatus to activate the secondary carrier for non-MBS data transmission.

19-25. (canceled)
